(19) United States
(12) Patent Application Publication
(10) Pub. No.: US 2025/0265345 A1
(43) Pub. Date: Aug. 21, 2025

(54) Vulnerability Defense System for Large Language Models

(71) Applicant: Cisco Technology, Inc., San Jose, CA (US)

(72) Inventor: Pallavi Kalapatapu, San Jose, CA (US)

(21) Appl. No.: 18/442,531

(22) Filed: Feb. 15, 2024

(51) Int. Cl. G06F 21/57; G06F 40/20

(52) U.S. Cl. CPC G06F 21/577; G06F 40/20

(57) ABSTRACT

A method for providing vulnerability defenses of LLMs to secure against generating responses to prompts that include vulnerabilities is provided. The method includes receiving a request including a prompt to be provided to a plurality of LLMs for generating a prediction of a response to the prompt, identifying, based on the prompt, one or more potential vulnerabilities associated with the plurality of LLMs generating the prediction of a response to the prompt, and determining, based on the identified one or more potential vulnerabilities, a vulnerability defense score associated with each of the plurality of LLMs. The vulnerability defense score includes an indication of a resistance of an LLM to generating a prediction of a response including one or more vulnerabilities. The method thus includes selecting, based on the vulnerability defense score, one of the plurality of LLMs for generating the prediction of a response to the prompt.

### TECHNICAL FIELD

This disclosure relates generally to large language models (LLMs), and, more specifically, to a vulnerability defense system for LLMs.

### BACKGROUND

Large language models (LLMs) may generally include machine-learning models suitable for predicting and generating textual responses in response to contextual prompts inputted by users. In most instances, LLMs may be suitable for facilitating and enhancing the web searching and browsing experiences of users by quickly generating responses to various questions, inquiries, and requests in a concise and contextual manner. However, in some instances, LLMs may be susceptible to adversarial attacks, which may include targeted prompts intended to manipulate LLMs to generate responses that include vulnerabilities, such as personal identification numbers (PINs), passwords, user personal data, user financial and transaction data, business entity proprietary information, proprietary source code, and so forth. It may be thus useful to provide to techniques to secure LLMs against adversarial attacks.

### BRIEF DESCRIPTION OF THE DRAWINGS

FIG. 1 illustrates a vulnerability defense generative artificial intelligence (AI) system utilized for providing vulnerability defenses LLM) to secure against generating responses to prompts that include vulnerabilities, in accordance with certain embodiments.

FIG. 2 illustrates a flow diagram of a method for providing vulnerability defenses of LLMs to secure against generating responses to prompts that include vulnerabilities, in accordance with certain embodiments.

FIG. 3 illustrates an example computing system that may be used by the systems and methods described herein, in accordance with certain embodiments.

### DESCRIPTION OF EXAMPLE EMBODIMENTS

### Overview

The present embodiments are directed to techniques for providing vulnerability defenses for large LLMs to secure against generating responses to prompts that include potential vulnerabilities. In certain embodiments, one or more processors of a vulnerability defense generative AI system may receive a request including a prompt to be provided to one or more of a number of LLMs for generating a prediction of a response to the prompt. For example, in one embodiment, the number of LLMs may include at least a first LLM, a second LLM, and a third LLM. In certain embodiments, the first LLM may be trained or fine-tuned based on a first data set including financial data, the second LLM may be trained or fine-tuned based on a second data set including medical data, and the third LLM may be trained or fine-tuned based on a third data set including technical data.

In certain embodiments, the one or more processors of the vulnerability defense generative AI system may then identify, based on the prompt, one or more potential vulnerabilities associated with the number of LLMs generating the prediction of a response to the prompt. For example, in certain embodiments, the one or more processors of the vulnerability defense generative AI system may identify the one or more potential vulnerabilities by identifying, based on a content of the prompt, a similarity to one or more prompts predetermined to include one or more vulnerabilities. In certain embodiments, the one or more processors of the vulnerability defense generative AI system may then determine, based on the identified one or more potential vulnerabilities, a vulnerability defense score associated with each of the plurality of LLMs. For example, in one embodiment, the vulnerability defense score may include an indication of a resistance of an LLM to generating a prediction of a response including one or more vulnerabilities.

In certain embodiments, the one or more processors of the vulnerability defense generative AI system may then select, based on the vulnerability defense score, one of the number of LLMs for generating the prediction of a response to the prompt. For example, in certain embodiments, prior to selecting the one of the number of LLMs, the one or more processors of the vulnerability defense generative AI system may rank each of the number of LLMs based on the vulnerability defense scores. In one embodiment, the one or more processors of the vulnerability defense generative AI system may rank each of the number of LLMs by ranking, based on the vulnerability defense scores, each of the number of LLMs utilizing a Bayesian hierarchical model. In certain embodiments, the one or more processors of the vulnerability defense generative AI system may select the one of the number of LLMs having a highest vulnerability defense score for generating the prediction of a response to the prompt, and then input the prompt into the selected one of the plurality of LLMs to generate the prediction of a response to the prompt.

A method, by one or more processors of a generative artificial intelligence (AI) system, includes receiving a request including a prompt to be provided to one or more of a plurality of large language models (LLMs) for generating a prediction of a response to the prompt, identifying, based on the prompt, one or more potential vulnerabilities associated with the plurality of LLMs, and determining, based on the one or more potential vulnerabilities, a vulnerability defense score associated with each of the plurality of LLMs Each of the vulnerability defense scores includes an indication of a resistance of the associated LLM to generating a prediction of a response that includes one or more vulnerabilities. The method includes selecting, based on the vulnerability defense score, one of the plurality of LLMs for generating the prediction of the response to the prompt.

A non-transitory computer-readable medium comprising instructions that, when executed by one or more processors of a computing system, cause the computing system to perform operations including receiving a request comprising a prompt to be provided to one or more of a plurality of large language models (LLMs) for generating a prediction of a response to the prompt, identifying, based on the prompt, one or more potential vulnerabilities associated with the plurality of LLMs, and determining, based on the one or more potential vulnerabilities, a vulnerability defense score associated with each of the plurality of LLMs. Each of the vulnerability defense scores includes an indication of a resistance of the associated LLM to generating a prediction of a response that includes one or more vulnerabilities. The instructions thus include selecting, based on the vulnerability defense score, one of the plurality of LLMs for generating the prediction of the response to the prompt.

Technical advantages of particular embodiments of this disclosure may include one or more of the following. Certain systems and methods described herein provide a vulnerability defense generative AI system utilized for providing vulnerability defenses for LLMs to secure against generating responses to prompts that include vulnerabilities (e.g., personal identification numbers (PINs), passwords, user personal data, user financial and transaction data, business entity proprietary information, proprietary source code, and so forth). In this way, the present embodiments may provide techniques to secure computing systems and safeguard against potential vulnerabilities and ensure uninterrupted operations across the vulnerability defense generative AI system, as well as with respect to the larger computing platform on which the vulnerability defense generative AI system may reside. Specifically, as generally described herein, the vulnerability defense generative AI system may identify and compensate for any potential vulnerabilities, and thereby increase the reliability and maintainability of the larger computing platform and the experiences of users serviced by the larger computing platform.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

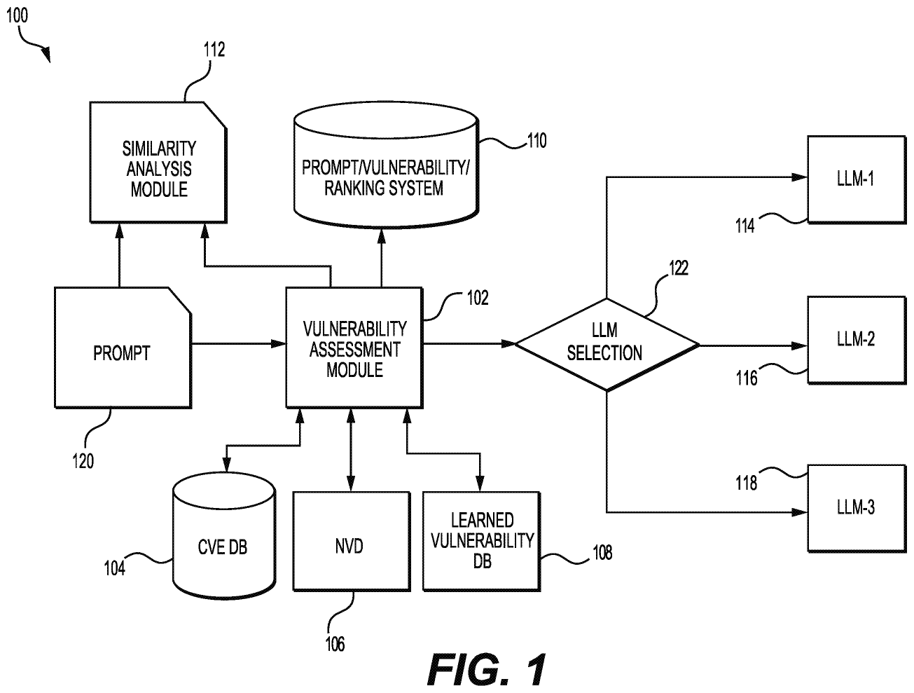

FIG. 1 illustrates a vulnerability defense generative AI system 100 utilized for providing vulnerability defenses of LLMs to secure against generating responses to prompts that include vulnerabilities, in accordance with the presently disclosed embodiments. As depicted by FIG. 1, the vulnerability defense generative AI system 100 may include a vulnerability assessment module 102, a common vulnerabilities and exposures (CVE) database 104, a national vulnerability database (NVD) 106, a learned vulnerabilities database 108, a prompt vulnerability ranking system 110, a prompt similarity analysis module 112, a first LLM 114 (e.g., “LLM-1”), a second LLM 116 (e.g., “LLM-2”), and a third LLM 118 (e.g., “LLM-3”).

In certain embodiments, as further depicted by FIG. 1, during an inference phase, the vulnerability defense generative AI system 100 may receive a request including a prompt 120 to be provided to one or more of the first LLM 114 (e.g., “LLM-1”), the second LLM 116 (e.g., “LLM-2”), or the third LLM 118 (e.g., “LLM-3”) for generating a prediction of a response to the prompt 120. For example, in certain embodiments, the first LLM 114 (e.g., “LLM-1”), the second LLM 116 (e.g., “LLM-2”), and the third LLM 118 (e.g., “LLM-3”) may each include a language model (LM) or a large language model (e.g., generative machine-learning models) trained or fine-tuned utilizing disparate data sets, but may otherwise include similar functionality and capabilities.

In one embodiment, the first LLM 114 (e.g., “LLM-1”) may be trained or fine-tuned based on a first data set including financial data, the second LLM 116 (e.g., “LLM-2”) may be trained or fine-tuned based on a second data set including medical data, and the third LLM 118 (e.g., “LLM-3”) may be trained or fine-tuned based on a third data set including technical data. In another embodiment, the first LLM 114 (e.g., “LLM-1”), the second LLM 116 (e.g., “LLM-2”), and the third LLM 118 (e.g., “LLM-3”) may each be pretrained based on a data set representative of a combination of financial data, medical data, technical data, literature, geographical data, and so forth, and then further fine-tuned to perform best on one of the financial data, the medical data, the technical data, the literature, the geographical data, etc. In certain embodiments, the prompt 120 may include any textual data that may be generated by a user or a prompt generation service and submitted to one or more of the first LLM 114 (e.g., “LLM-1”), the second LLM 116 (e.g., “LLM-2”), and the third LLM 118 (e.g., “LLM-3”) in order to illicit a generated response thereto.

In certain embodiments, upon the vulnerability defense generative AI system 100 receiving the prompt 120, the vulnerability assessment module 102 may then analyze the prompt 120 to identify one or more potential vulnerabilities associated with one or more of the first LLM 114 (e.g., “LLM-1”), the second LLM 116 (e.g., “LLM-2”), or the third LLM 118 (e.g., “LLM-3”) generating the prediction of a response to the prompt 120. Specifically, the vulnerability assessment module 102 may include a software module suitable for analyzing the prompt 120 and accessing whether the prompt 120 includes any potential vulnerabilities or correspond, for example, to an adversarial attack intended for one or more of the first LLM 114 (e.g., “LLM-1”), the second LLM 116 (e.g., “LLM-2”), and the third LLM 118 (e.g., “LLM-3”).

Specifically, the vulnerability assessment module 102 may be utilized to analyze the prompt 120 to identify, for example, whether the prompt 120 includes any textual content that may cause one or more of the first LLM 114 (e.g., “LLM-1”), the second LLM 116 (e.g., “LLM-2”), and the third LLM 118 (e.g., “LLM-3”) generate a prediction of a response to the prompt 120 that includes vulnerabilities, such as personal identification numbers (PINs), passwords, user personal data, user financial and transaction data, business entity proprietary information, proprietary source code, and so forth. For example, in certain embodiments, the vulnerability assessment module 102 may utilize the prompt similarity analysis module 112 to compare a textual content (e.g., including semantics and context) of the prompt 120 to textual content stored to one or more of the CVE database 104, the NVD 106, and the learned vulnerabilities database 108 to identify similarities between the textual content (e.g., including semantics and context) of the prompt 120 and the stored textual content.

In certain embodiments, the CVE database 104, the NVD 106, and the learned vulnerabilities database 108 may each include a repository or a data lake of textual content or other data predetermined to include one or more vulnerabilities. For example, the CVE database 104 and the NVD 106 may each include external databases of historical vulnerabilities. In one embodiment, the learned vulnerabilities database 108 may include, for example, an internal relational database of historical vulnerabilities learned over time based on the generated responses of the first LLM 114 (e.g., “LLM-1”), the second LLM 116 (e.g., “LLM-2”), and the third LLM 118 (e.g., “LLM-3”). In certain embodiments, upon identifying one or more potential vulnerabilities based on the prompt 120, the vulnerability assessment module 102 may then provide an output corresponding to the identified one or more potential vulnerabilities to the prompt vulnerability ranking system 110.

In certain embodiments, in response to receiving the output corresponding to the identified one or more potential vulnerabilities, the prompt vulnerability ranking system 110 may then determine a vulnerability defense score associated with each of the first LLM 114 (e.g., “LLM-1”), the second LLM 116 (e.g., “LLM-2”), and the third LLM 118 (e.g., “LLM-3”). For example, in some embodiments, the vulnerability defense score may include a value (e.g., from “0” to “100” or “0.0” to “1.0”) indicative of a resistance of the first LLM 114 (e.g., “LLM-1”), the second LLM 116 (e.g., “LLM-2”), and the third LLM 118 (e.g., “LLM-3”) to generating a prediction of a response including one or more vulnerabilities in response to the prompt 120.

Specifically, in one embodiment, the prompt vulnerability ranking system 110 may determine the vulnerability defense score associated with each of the first LLM 114 (e.g., “LLM-1”), the second LLM 116 (e.g., “LLM-2”), and the third LLM 118 (e.g., “LLM-3”) by matching the prompt 120 to the one of the first LLM 114 (e.g., “LLM-1”), the second LLM 116 (e.g., “LLM-2”), and the third LLM 118 (e.g., “LLM-3”) trained best to resist possible generation of response including vulnerabilities. For example, in one such a case in which the prompt 120 elicits financial information (e.g., “What internal factors will impact the future share price of Company A?”), the prompt vulnerability ranking system 110 may determine a vulnerability defense score of “0.8” or greater for the first LLM 114 (e.g., “LLM-1”) having been trained or fine-tuned on financial data sets and financial data vulnerabilities and a vulnerability defense score of “0.2” or less for the second LLM 116 (e.g., “LLM-2”) having been trained or fine-tuned on medical data sets and medical data vulnerabilities.

In certain embodiments, the prompt vulnerability ranking system 110 may further rank each of the first LLM 114 (e.g., “LLM-1”), the second LLM 116 (e.g., “LLM-2”), and the third LLM 118 (e.g., “LLM-3”) based on their respective vulnerability defense scores. For example, in some embodiments, the prompt vulnerability ranking system 110 may rank each of the first LLM 114 (e.g., “LLM-1”), the second LLM 116 (e.g., “LLM-2”), and the third LLM 118 (e.g., “LLM-3”) utilizing a hierarchical Bayesian model. For example, the hierarchical Bayesian model may include latent variables representing vulnerability resistance of each of the first LLM 114 (e.g., “LLM-1”), the second LLM 116 (e.g., “LLM-2”), and the third LLM 118 (e.g., “LLM-3”) modeled as a higher-level distribution, which may allow for response learnings learned over time to be shared across each of the first LLM 114 (e.g., “LLM-1”), the second LLM 116 (e.g., “LLM-2”), and the third LLM 118 (e.g., “LLM-3”). Specifically, the hierarchical Bayesian model may be utilized to identify a set of probabilities indicative vulnerability resistance of each of the first LLM 114 (e.g., “LLM-1”), the second LLM 116 (e.g., “LLM-2”), and the third LLM 118 (e.g., “LLM-3”) that takes into account the vulnerability defense scores and the content (e.g., semantics, context, syntax, word frequency, and so forth) of the prompt 120.

In certain embodiments, upon the prompt vulnerability ranking system 110 ranking each of the first LLM 114 (e.g., “LLM-1”), the second LLM 116 (e.g., “LLM-2”), and the third LLM 118 (e.g., “LLM-3”) based on their respective vulnerability defense scores, the vulnerability assessment module 102 may then select one of the first LLM 114 (e.g., “LLM-1”), the second LLM 116 (e.g., “LLM-2”), and the third LLM 118 (e.g., “LLM-3”) for generating the prediction of a response to the prompt 120. For example, as further depicted by FIG. 1, the vulnerability assessment module 102 utilize the respective vulnerability defense scores and rankings of the first LLM 114 (e.g., “LLM-1”), the second LLM 116 (e.g., “LLM-2”), and the third LLM 118 (e.g., “LLM-3”) to generate a selection 122 of the one of the first LLM 114 (e.g., “LLM-1”), the second LLM 116 (e.g., “LLM-2”), and the third LLM 118 (e.g., “LLM-3”) having a highest vulnerability defense score for generating the prediction of a response to the prompt 120. The vulnerability assessment module 102 and then input the prompt 120 into the selected one of the first LLM 114 (e.g., “LLM-1”), the second LLM 116 (e.g., “LLM-2”), and the third LLM 118 (e.g., “LLM-3”) for generating the prediction of a response to the prompt 120.

Accordingly, the present embodiments may provide a resilient generative AI system 100 utilized for providing defenses of LLMs against generating responses to prompts that include vulnerabilities (e.g., personal identification numbers (PINs), passwords, user personal data, user financial and transaction data, business entity proprietary information, proprietary source code, and so forth). In this way, the present embodiments may provide techniques to secure computing systems and safeguard against potential vulnerabilities and ensure uninterrupted operations across the vulnerability defense generative AI system 100, as well as with respect to the larger computing platform on which the vulnerability defense generative AI system 100 may reside. Specifically, as generally described herein, the vulnerability defense generative AI system 100 may identify and compensate for any potential vulnerabilities, and thereby reduce the possibility of adversely impacting the reliability of the larger computing platform and the experiences of users serviced by the larger computing platform.

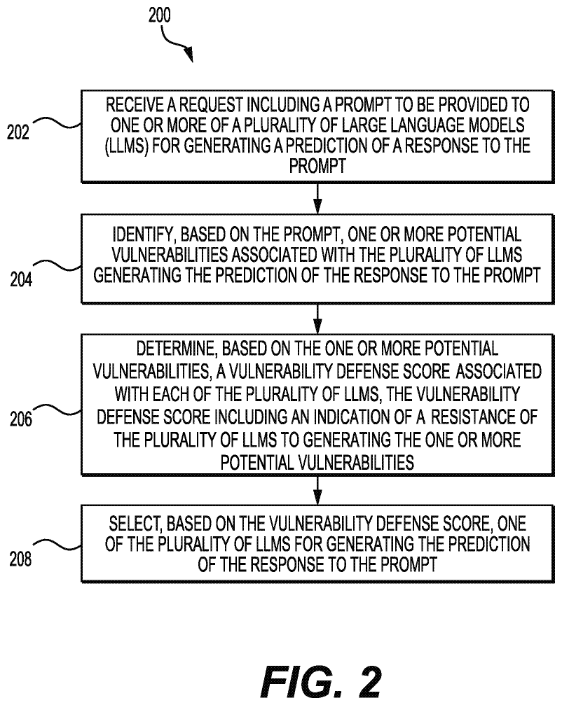

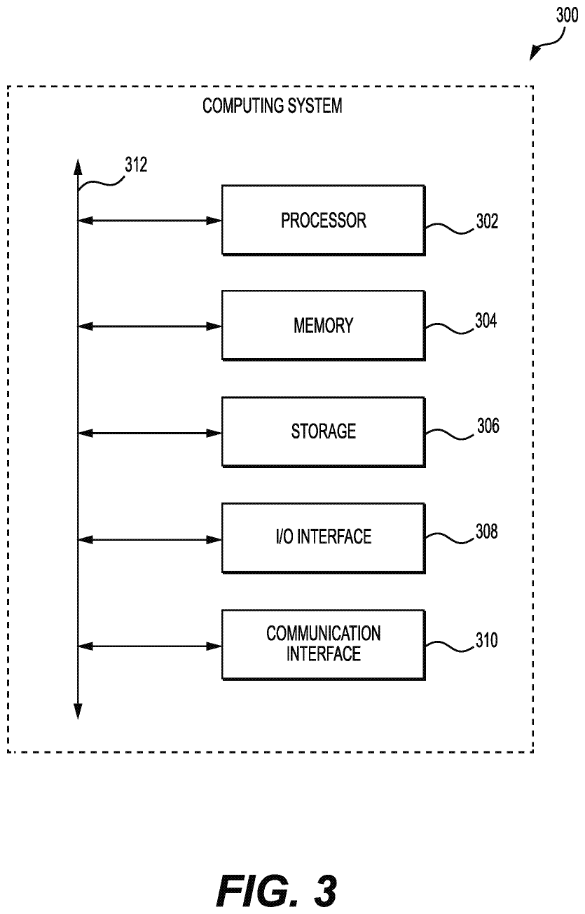

FIG. 2 illustrates a flow diagram of a method 200 for providing vulnerability defenses of LLMs to secure against generating responses to prompts that include vulnerabilities, in accordance with the presently disclosed embodiments. The method 200 may be performed utilizing one or more processing devices (e.g., one or more processors 302 as discussed below with respect to FIG. 3) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other artificial intelligence (AI) accelerator device(s) that may be suitable for processing various data and making one or more predictions or decisions based thereon), firmware (e.g., microcode), or some combination thereof.

The method 200 may begin at block 202 with the one or more processors (e.g., one or more processors 302) receiving a request including a prompt (e.g., prompt 120 of FIG. 1) to be provided to one or more of a plurality of LLMs (e.g., first LLM 114, second LLM 116, and third LLM 118 of FIG. 1) for generating a prediction of a response to the prompt. For example, in certain embodiments, the plurality of LLMs (e.g., first LLM 114, second LLM 116, and third LLM 118 of FIG. 1) may include a first LLM trained or fine-tuned based on a first data set including financial data, a second LLM trained or fine-tuned based on a second data set including medical data, and a third LLM trained or fine-tuned based on a third data set including technical data. The method 200 may continue at block 204 with the one or more processors (e.g., one or more processors 302) identifying, based on the prompt, one or more potential vulnerabilities associated with the plurality of LLMs (e.g., first LLM 114, second LLM 116, and third LLM 118 of FIG. 1) generating the prediction of the response to the prompt (e.g., prompt 120 of FIG. 1). For example, in certain embodiments, the one or more processors (e.g., one or more processors 302) may identify the one or more potential vulnerabilities by identifying, based on a content of the prompt, a similarity to one or more prompts prompt (e.g., prompt 120 of FIG. 1) predetermined to include one or more vulnerabilities.

The method 200 may continue at block 206 with the one or more processors (e.g., one or more processors 302) determining, based on the identified one or more potential vulnerabilities, a vulnerability defense score associated with each of the plurality of LLMs (e.g., first LLM 114, second LLM 116, and third LLM 118 of FIG. 1). For example, in one embodiment, each respective vulnerability defense score may include an indication of a resistance of each of the plurality of LLMs to generating the one or more potential vulnerabilities. The method 200 may conclude at block 208 with the one or more processors (e.g., one or more processors 302) selecting (e.g., LLM selection 122 of FIG. 1), based on the vulnerability defense score, one of the plurality of LLMs (e.g., first LLM 114, second LLM 116, and third LLM 118 of FIG. 1) for generating the prediction of a response to the prompt. For example, in certain embodiments, the one or more processors (e.g., one or more processors 302) may select the one of the plurality of LLMs (e.g., first LLM 114, second LLM 116, and third LLM 118 of FIG. 1) having a highest vulnerability defense score for generating the prediction of a response to the prompt and further inputting the prompt (e.g., prompt 120 of FIG. 1) into the selected one of the plurality of LLMs (e.g., first LLM 114, second LLM 116, and third LLM 118 of FIG. 1) to generate the prediction of a response to the prompt (e.g., prompt 120 of FIG. 1).

FIG. 3 illustrates an example computer system 300 that may be useful in performing one or more of the foregoing techniques as presently disclosed herein. In certain embodiments, one or more computer systems 300 perform one or more steps of one or more methods described or illustrated herein. In certain embodiments, one or more computer systems 300 provide functionality described or illustrated herein. In certain embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein.

As an example, and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate. In certain embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In certain embodiments, processor 302 includes hardware for executing instructions, such as those making up a computer program. As an example, and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In certain embodiments, processor 302 may include one or more internal caches for data, instructions, or addresses. This disclosure contemplates processor 302 including any suitable number of any suitable internal caches, where appropriate. As an example, and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302.

Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In certain embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 602. Although this disclosure describes and illustrates a particular processor, this disclosure contemplates any suitable processor.

In certain embodiments, memory 304 includes main memory for storing instructions for processor 302 to execute or data for processor 302 to operate on. As an example, and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In certain embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere).

One or more memory buses (which may each include an address bus and a data bus) may couple processor 302 to memory 304. Bus 312 may include one or more memory buses, as described below. In certain embodiments, one or more memory management units (MMUs) reside between processor 302 and memory 304 and facilitate accesses to memory 304 requested by processor 302. In certain embodiments, memory 304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In certain embodiments, storage 306 includes mass storage for data or instructions. As an example, and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In certain embodiments, storage 306 is non-volatile, solid-state memory. In certain embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In certain embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In certain embodiments, communication interface 310 includes hardware, software, or both providing one or more interfaces for communication (such as, for example, packet-based communication) between computer system 300 and one or more other computer systems 300 or one or more networks. As an example, and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it.

As an example, and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In certain embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, by one or more processors of a generative artificial intelligence (AI) system, comprising:
receiving a request comprising a prompt to be provided to one or more of a plurality of large language models (LLMs) for generating a prediction of a response to the prompt;
identifying, based on the prompt, one or more potential vulnerabilities associated with the plurality of LLMs generating the prediction of the response to the prompt;
determining, based on the one or more potential vulnerabilities, a vulnerability defense score associated with each of the plurality of LLMs, wherein each respective vulnerability defense score comprises an indication of a resistance of each of the plurality of LLMs to generating the one or more potential vulnerabilities; and
selecting, based on the vulnerability defense score, one of the plurality of LLMs for generating the prediction of the response to the prompt.

2. The method of claim 1, wherein the plurality of LLMs comprises at least a first LLM, a second LLM, and a third LLM.

3. The method of claim 2, wherein:
the first LLM is trained or fine-tuned based on a first data set comprising financial data;
the second LLM is trained or fine-tuned based on a second data set comprising medical data; and
the third LLM is trained or fine-tuned based on a third data set comprising technical data.

4. The method of claim 1, further comprising:
prior to selecting the one of the plurality of LLMs, ranking each of the plurality of LLMs based on the vulnerability defense scores.

5. The method of claim 4, wherein ranking each of the plurality of LLMs comprises ranking, based on the vulnerability defense scores, each of the plurality of LLMs utilizing a Bayesian hierarchical model.

6. The method of claim 4, further comprising:
selecting the one of the plurality of LLMs having a highest vulnerability defense score for generating the prediction of the response to the prompt; and
inputting the prompt into the selected one of the plurality of LLMs to generate the prediction of the response to the prompt.

7. The method of claim 1, wherein identifying the one or more potential vulnerabilities comprises identifying, based on a content of the prompt, a similarity to one or more prompts predetermined to include one or more vulnerabilities.

8. A computing system comprising one or more processors and one or more computer-readable non-transitory storage media coupled to the one or more processors and including instructions that, when executed by the one or more processors, cause the computing system to perform operations comprising:
receiving a request comprising a prompt to be provided to one or more of a plurality of large language models (LLMs) for generating a prediction of a response to the prompt;
identifying, based on the prompt, one or more potential vulnerabilities associated with the plurality of LLMs generating the prediction of the response to the prompt;
determining, based on the one or more potential vulnerabilities, a vulnerability defense score associated with each of the plurality of LLMs, wherein each respective vulnerability defense score comprises an indication of a resistance of each of the plurality of LLMs to generating the one or more potential vulnerabilities; and
selecting, based on the vulnerability defense score, one of the plurality of LLMs for generating the prediction of the response to the prompt.

9. The computing system of claim 8, wherein the plurality of LLMs comprises at least a first LLM, a second LLM, and a third LLM.

10. The computing system of claim 9, wherein:
the first LLM is trained or fine-tuned based on a first data set comprising financial data;
the second LLM is trained or fine-tuned based on a second data set comprising medical data; and
the third LLM is trained or fine-tuned based on a third data set comprising technical data.

11. The computing system of claim 8, wherein the instructions further comprise instructions to:
prior to selecting the one of the plurality of LLMs, rank each of the plurality of LLMs based on the vulnerability defense scores.

12. The computing system of claim 11, wherein the instructions to rank each of the plurality of LLMs further comprise instructions to rank, based on the vulnerability defense scores, each of the plurality of LLMs utilizing a Bayesian hierarchical model.

13. The computing system of claim 11, wherein the instructions further comprise instructions to:
select the one of the plurality of LLMs having a highest vulnerability defense score for generating the prediction of the response to the prompt; and
input the prompt into the selected one of the plurality of LLMs to generate the prediction of the response to the prompt.

14. The computing system of claim 8, wherein the instructions to identify the one or more potential vulnerabilities further comprise instructions to identify, based on a content of the prompt, a similarity to one or more prompts predetermined to include one or more vulnerabilities.

15. A non-transitory computer-readable medium comprising instructions that, when executed by one or more processors of a computing system, cause the computing system to perform operations comprising:
receiving a request comprising a prompt to be provided to one or more of a plurality of large language models (LLMs) for generating a prediction of a response to the prompt;
identifying, based on the prompt, one or more potential vulnerabilities associated with the plurality of LLMs generating the prediction of the response to the prompt;
determining, based on the one or more potential vulnerabilities, a vulnerability defense score associated with each of the plurality of LLMs, wherein each respective vulnerability defense score comprises an indication of a resistance of each of the plurality of LLMs to generating the one or more potential vulnerabilities; and
selecting, based on the vulnerability defense score, one of the plurality of LLMs for generating the prediction of the response to the prompt.

16. The non-transitory computer-readable medium of claim 15, wherein the plurality of LLMs comprises at least a first LLM, a second LLM, and a third LLM.

17. The non-transitory computer-readable medium of claim 15, wherein the instructions further comprise instructions to:
prior to selecting the one of the plurality of LLMs, rank each of the plurality of LLMs based on the vulnerability defense scores.

18. The non-transitory computer-readable medium of claim 17, wherein the instructions to rank each of the plurality of LLMs further comprise instructions to rank, based on the vulnerability defense scores, each of the plurality of LLMs utilizing a Bayesian hierarchical model.

19. The non-transitory computer-readable medium of claim 17, wherein the instructions further comprise instructions to:
select the one of the plurality of LLMs having a highest vulnerability defense score for generating the prediction of the response to the prompt; and
input the prompt into the selected one of the plurality of LLMs to generate the prediction of the response to the prompt.

20. The non-transitory computer-readable medium of claim 15, wherein the instructions to identify the one or more potential vulnerabilities further comprise instructions to identify, based on a content of the prompt, a similarity to one or more prompts predetermined to include one or more vulnerabilities.
